(19) United States
(12) Patent Application Publication
(10) Pub. No.: US 2009/0259537 A1
(43) Pub. Date: Oct. 15, 2009

(54) ADVERTISEMENT-FUNDED SOFTWARE

(75) Inventors: Polina Veksler, Boca Raton, FL (US); Zachary A. Apter, Seattle, WA (US); Brian James Utter, Seattle, WA (US); Alexander G. Gounares, Kirkland, WA (US); Kamal Jain, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/102,189

(22) Filed: Apr. 14, 2008

(51) Int. Cl. G06Q 30/00; G06Q 40/00

(52) U.S. Cl. 705/14; 705/40; 705/44

(57) ABSTRACT

Systems and methods are provided to directly compensate an agent that utilizes a software application in exchange for the agent's intent in using the application, and for displaying intent-driven advertisement to the agent. Intent is inferred through information received from the agent, when utilizing the software application, according to an agent's privacy settings. Based on agent's intent, an advertisement is displayed and an associated software-related compensation is provided to the agent. Compensation accumulation profiles can be established based at least in part on privacy settings. Compensation possesses monetary value and can be directed towards (i) increasing software functionality, (ii) providing credits for training and literature related to the utilization of the application, or (iii) servicing a device in which the application is executed. The monetary aspect of the software-related compensation originated in intent-driven advertisement effectively funds the agent's software application.

### TECHNICAL FIELD

The subject specification relates to systems and methods for compensating an agent that utilizes a software application in exchange for the agent's intent in using the application, and for displaying advertisement to the agent in response to the intent.

### BACKGROUND

In conventional user-service provider interaction, a user or agent selects a service or goods provider based on an expectation that the provider would deliver relevant and competent service that would satisfy the needs of the agent. In addition, cost-benefit analysis generally contributes to the selection process, with the agent seeking the most value among available alternative. Once a selection is made—either a service provider is engage in a commercial transaction, or a product is bought from a merchant—the agent conveys intent in accessing the service or utilizing a product. In response to the provided intent, an adequate selection of service provider or product generally leads service or product satisfaction. In such a commercial paradigm, service providers and merchants typically compete for agent's intent by offering quality service and products while campaigning for brand recognition and awareness, as well as service or product differentiation. It should be appreciated, notwithstanding that advertising efforts and agent's intent are either primarily disjointed or marginally exploited. Furthermore, merchants and product distributors generally pursue independent advertisement campaigns.

The above mentioned predominant disconnect between advertisement efforts and agent's intent, as well as disjointed merchant-distributor advertisement efforts can significantly undermine efforts for product penetration and recognition. Additionally, disjointed efforts can result in missed synergistic opportunities between product drivers (e.g., merchant, distributors, and service providers). More importantly, synergistic commercial opportunities between product drivers and product adopters can also be missed. As an example of missed opportunities between market forces among merchants and consumers can be illustrated with software applications in scenarios where users have few options to access licensed software. In such scenarios, agents (e.g., a single user, or a group of users) oftentimes would turn to pirate copies of licensed software. Even when agents avoid turning to piracy, it appears likely that such agents would consider open-source software applications. Clearly, tendencies like resorting to piracy and leaning toward open-source software not only can result in loss of market share or opportunities for product penetration, but it can allow lost revenues for developers of licensed software and its distributors. Moreover, the foregoing tendencies can also affect agents as pirated copies are not supported and open-source applications demand a certain level of savvy to leverage off community efforts that offer support through user groups, blogs, and web-based boards.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject specification discloses systems and methods are provided for an intent-compensation commercial model that directly compensates an agent that utilizes a software application in exchange for the agent's intent in using the application, and for displaying advertisement to the agent in response to the intent. Intent can be inferred through information received from the agent when utilizing the software application and according to the agent's privacy settings. Intent inference and privacy settings can be accomplished through an interface that links the agent with a service provider that delivers the advertisement and provides the compensation. Based on inferred agent's intent, an intent-specific advertisement is displayed to the agent and an associated software-related compensation is provided.

Compensation accumulation profiles can be established based at least in part on privacy settings determined by the agent. A single agent can determine multiple privacy settings, and such settings can be associated with multiple applications. Compensation possesses monetary value and can be facilitated through advertisement spend received by a service platform from an advertisement engine. Compensation can be directed towards (a) increasing software functionality, (b) providing credits for training and literature related to the utilization of the application, or (c) servicing a device in which the application is executed. The software-related compensation provided to an agent has monetary value and originates primarily on intent-driven advertisement; therefore, such compensation can effectively fund the agent's software application through advertisement.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and novel features of the claimed subject matter will become apparent from the following detailed description of the claimed subject matter when considered in conjunction with the drawings.

### BRIEF DESCRIPTION OF THE DRAWINGS

FIG. 1 illustrates a high-level block diagram of an example system that provides advertisement funded software applications in accordance with aspects disclosed in the subject specification.

FIG. 2 is a block diagram of an example interface that establishes the intent of an agent.

FIGS. 3A and 3B illustrate, respectively, an example of a privacy component and an intelligent component according to aspects describe in the subject specification.

FIGS. 4A and 4B illustrate, respectively, example advertisement displays in accordance with aspects set forth herein.

FIG. 5 illustrates accumulation profiles of software-related compensation versus intent-driven advertisement impressions, and examples of software-related compensations in accordance with aspects described herein.

FIG. 6 illustrates a block diagram of an example system that employs ad spend to compensate an agent in exchange of the agent's intent and display of an intent-driven advertisement.

FIG. 7 presents a flowchart of an example method for funding software through intent-driven advertisement.

FIG. 8 presents a flowchart of an example method for establishing intent associated with a software application registered in an intent-compensation ad-fund software model according to aspects described in the subject specification.

FIG. 9 presents a flowchart of an example method for generating a software-related intent-based compensation in response to advertisement exposure according to aspects set forth herein.

FIGS. 10 and 11 illustrate computing environments for carrying out various aspects described in the subject specification.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Further, the terms “component,” “system,” “module,” “platform,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

As employed herein, the terms “agent,” “user,” “customer,” “player,” “participant” and the like generally refer to a human entity (e.g., a single person or group of people) that utilizes a software application (e.g., plays, participates in, or employs a computer-implemented game; or utilizes a utility software application like presentation-preparation software, data-analysis software, online investment and related business transactions, navigation software; and so on) and possesses access to computer-related communication infrastructure, computer-related systems, electronic devices, portable or otherwise, or any combination thereof. The aforementioned terms can be, and often are, hereinafter employed interchangeably.

Furthermore, the term “service” can refer to executing a software, such as using a toolbar or web-based email engine; retrieving information (e.g., status of a pending patent application, a proposal submission, immigration process, or package delivery); purchasing goods; making a payment (e.g. mortgage, rent, student loan, credit card, car, phone, utilities, late fees); taking a class at an online school; making an appointment with an offline provider (e.g., dentist, medical doctor, lawyer, hairdresser, mechanic); or registering for an online or offline conference. It should be appreciated that this listing of services is provided as an illustration.

In the subject specification, systems and methods for an intent-compensation commercial model are provided. The model contemplates directly compensating an agent that utilizes a software application in exchange for the agent's intent in using the application, and for displaying advertisement to the agent in response to the intent. Such intent can be inferred through information received from the agent when utilizing the software application and according to the agent's privacy settings. Based on agent's intent, an advertisement is displayed and an associated software-related compensation is provided to the agent.

Compensation accumulation profiles can be established based at least in part on privacy settings determined by the agent. A single agent can determine multiple privacy settings, and such settings can be associated with multiple applications. Compensation possesses monetary value and can be facilitated through advertisement spend received by a service platform from an advertisement engine. Compensation can be directed towards (i) increasing software functionality, (ii) providing credits for training and literature related to the utilization of the application, or (iii) servicing a device in which the application is executed. The monetary aspect of the software-related compensation originated in intent-driven advertisement effectively funds the agent's software application. Next, details of the foregoing aspect as described in detail.

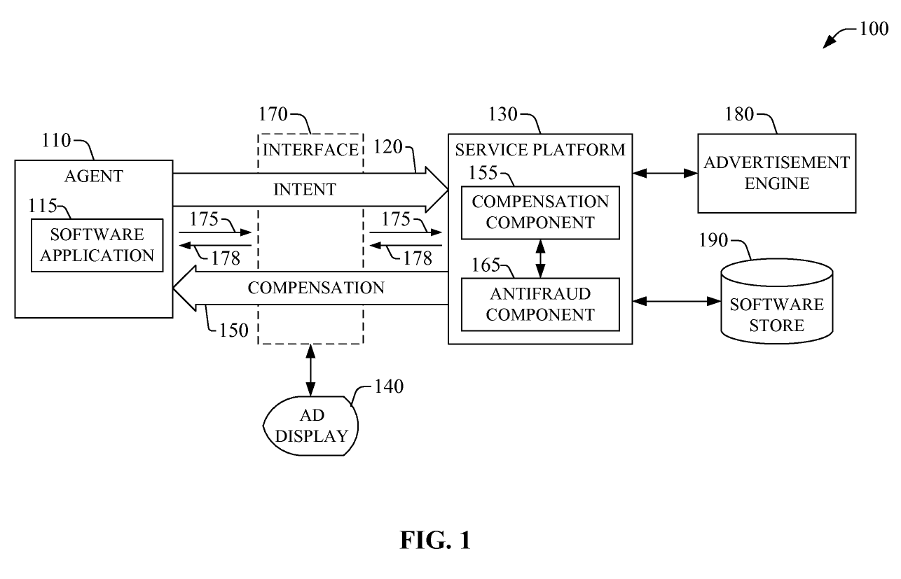

FIG. 1 illustrates a high-level block diagram of an example system that provides advertisement-funded software application(s). An agent 110 that has access to a software application 115, typically running in an electronic device (e.g., wired or wireless; stationary or mobile), conveys intent 120 to a service platform 130 which in return of the user's intent displays an intent-driven advertisement 140. Generation of an advertisement impression 140 is rewarded through compensation 150. Such compensation is provided by service platform 130 and generally related, at least in part, to the software application 115 that drives intent disclosure by agent 110 or intent discovery by service platform 130. Additionally or alternatively, compensation 150 can be directed toward the electronic device in which application 115 is executed. It is to be noted that advertisement driven compensation effectively is an instrument to fund at least in part software application 115.

In order to participate in the ad-funded software initiative of service platform 130, and receive compensation 150 in exchange for intent 120 associated to utilization of software application 115, agent 110 can be required to register with service platform 130. It should be appreciated that agent 110 can sign-up for intent-based compensation at the time of accessing software application for a first time (e.g., at the time of buying a licensed copy of the application, or downloading a freeware or limited-time licensed copy), or at a later time typically within a predetermined time frame. Agent registration generally results in user intelligence associated with the agent, and can facilitate customization of compensation 150 to specific characteristics (e.g., interests) of agent 110. Depending on marketing strategy of service platform 130 and the disposition of agent 110 towards privacy, collected user intelligence can include varied demographic information (e.g., ethnic background, level of education, marital status, employer, and the like). Service platform 130 can deliver and manage compensation 150 through a compensation component 155. Typically, such compensation possesses monetary value; accordingly, an antifraud component 165 can ensure that bona fide intent is rewarded.

Antifraud component 165 can implement multiple mechanisms for fraud prevention. In an aspect, in order to account advertisement impressions towards intent-based compensation, antifraud component 165 can ensure software application 115 is actually used by agent 115 instead of an automated script (e.g., a robot) that emulated the agent. As an example, antifraud component 165 can implement variations of Turing tests to discern whether an agent 110 is utilizing software application 115. In another aspect, antifraud component can probe temporal variations of intent, as legitimate utilization of software 115 can lead to disparate intents within a specific period of time. In yet another aspect, antifraud component 165 can reduce the frequency at which an advertisement impression 140 is generated during a specific session of use of software application 115. In particular, after extended periods of continued use without response to advertisement or collection of new user intelligence, service platform 130 can substantially stop displaying advertisement, and associated software-related compensation 150.

In system 100, intent 120, advertisement display 140, and compensation 150 can be processed via an interface 170. Through forward link (FL) 175 and reverse link (RL) 178, interface 170 affords, respectively, traffic (e.g., data, control and management information) between agent 110 and service platform 130, and service platform 130 and agent 110. FL 175 and RL 179 can be substantially any type of communication link, either wired (e.g., a T-carrier like T1 phone line, an E-carrier such as an E1 phone line, a T1/E1 carrier, a T1/E1/J1 carrier, a twisted-pair link, an optical fiber, and so on) or wireless (e.g., Ultra-mobile Broadband (UMB), Long Term Evolution (LTE), Wireless Fidelity (Wi-Fi), etc.), or any combination thereof.

Service platform 130 generates advertisement through an associated advertisement engine 180. In an aspect, engine 180 can be part of a merchant which utilizes service platform 130 as an advertisement service or broker. In another aspect, advertisement engine can be an advertisement intermediary between service platform 130 and a set of disparate merchants. In yet another aspect, advertisement engine 180 can be an integral part of, and managed by, service platform 130. Furthermore, software application 115 can be developed by service platform 130, or can be distributed thereby on behalf of its developer (not shown). In either scenario, software applications, e.g., application 115, are generally stored in software store 190. Alternatively or in addition, a software application 115 can be developed, retailed and distributed through a disparate service platform.

It should be appreciated that example system 100 illustrates a commercial model that exploit synergies among the service platform 130, a software (e.g., product) developers (not shown) and distributors, as well as agent(s). By displaying intent-based advertisement in response to agent's intent, advertisement engine 180 can access a high-quality audience, which intrinsically offers the prospect(s) of increased return-on-investment. Moreover, in view of software-related compensation, agent 110 can obtain a high value by employing software applications that participate in the intent-compensation ad-funded software commercial model. In addition, by having access to an intrinsically targeted audience (e.g., user of software application 115), and associated user intelligence, service platform 130 can provide complementary services of possible interest to agent(s), thus increasing its user share.

Various aspects of associated with funding software through intent-driven advertisement are discussed next.

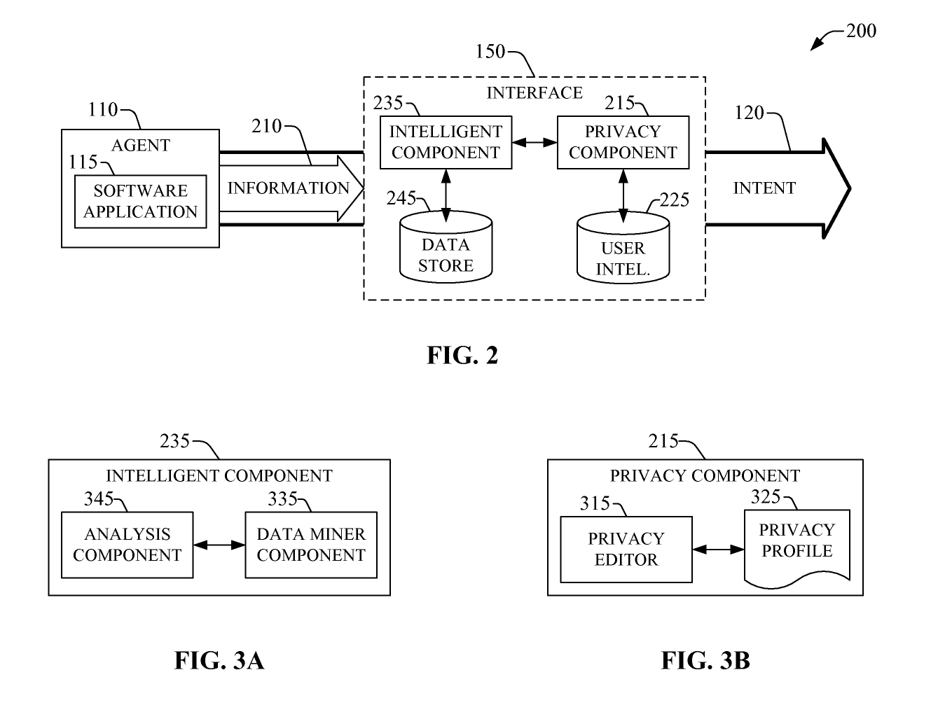

FIG. 2 is a block diagram 200 of an example interface that establishes agent's intent. Interface 150 receives information 210 from agent 110 at the time of utilizing software application 115. It is to be noted that the utilizing the software comprises downloading or installing a copy of the application, or executing the application with a particular objective. Whereas information 210 related to registering and downloading a copy of software 115, such information is static in that it does not varies when agent 110 utilizes the application 115. Alternatively, information 210 related to executing the software is dynamic, as software application can be employed in multiple instances in disparate scenarios, which can lead the agent to face alternative, increasingly complex scenarios. A wealth of information 210 associated with several scenarios manipulated by agent 110 is conveyed to interface 170. As an example, agent 110 can generate information 210 as a result of employing Microsoft® Visio® to prepare a set of slides for a presentation, in view that each presentation can be directed toward different topic, or material, or disparate audiences, agent 110 can exploit disparate functionalities (e.g., stencils, object settings, dimensioning, etc.) of the application. As am additional example, agent 110 can utilize an online application (e.g., provided by service platform 130) to invest in stocks in various worldwide stock markets, as investing strategies become more sophisticated the agent can rely on increasingly complex market(s)/portfolio analysis tools. In yet another example, agent 110 can participate in a massively multiplayer online game which can lead the agent to access online maps associated with various scenarios in the game, as well as strategies to optimize resources accrued through specific tasks within the game, or tutorial information associated with particular challenges posed throughout the game.

Interface 170 can utilize a privacy component 215 to apportion collected information 210 to generate intent. Agent 110 who participates in an intent-compensation model for funding software through advertisement can determine dynamically the level of information that is to be utilized by interface 170 to establish agent's intent. User intelligence 235 regarding agent 110 is employed by privacy component 215 to facilitate a determination of intent 120. As discussed above, user intelligence can be collected at the time of agent 110 registers to participate in an ad-funded software program. Interface 170 exploits an intelligent component 235 to infer agent's intent 120. Such intelligent component 235 generates, and relies, on data stored in a memory 235.

Intelligent component 235 can reason or draw conclusions about, e.g., infer, a current or future intent of agent 110, or generally a system that includes agent 110, based on existing information about the agent or system that includes said agent. In addition to inferring intent, intelligent component 235 can thus be employed to identify a specific context of, or action related to, the inferred intent 120. Furthermore, intelligent component 235 can generate a probability distribution of specific states of an agent, or system that includes an agent, and associated intent 120 without human intervention. To infer intent 120, intelligent component 235 relies on artificial intelligence techniques, which apply advanced mathematical algorithms—e.g., decision trees, neural networks, regression analysis, cluster analysis, genetic algorithm, and reinforced learning—to a set of available (as it can be determined by privacy component 215) information on the agent 110, or a system that include the agent.

In particular, the intelligent component 235 can employ one of numerous methodologies for learning from data and then drawing inferences from the models so constructed, e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

Intent 120 can be explicit, like in instances in which agent 110 utilizes a search engine, or queries specific information in databases or merchant websites. Alternatively, intent 20 can be implicit and therefore inference-based can be necessary to determine agent's intent. As an example, a user that utilizes Microsoft® PowerPoint® and frequently access the Help engine of the application can indicate a “learning,” “training,” or “reference” intent. Such an agent can then be presented with an advertisement for literature related to Microsoft® PowerPoint®, e.g., “PowerPoint® for Dummies,” or with advertisement for PowerPoint online training or onsite training at a location near agent 110. It is to be noted that the nature of the intent-driven advertisement depends on the privacy settings established by the agent, as the degree of confidence in inferring intent is greatly influenced by available contextual information. Accordingly, intent 120 can be inferred with various degrees of confidence. The degree of confidence depends primarily on the available information extracted or gleaned from information 210. As compensation is attained through intent-based advertisement impressions, agent 110 can tune the rate at which compensation 150 is received, and also the quality of the compensation 150 that is received, by adjusting a privacy setting.

FIGS. 3A and 3B illustrate, respectively, examples of privacy component 215 and intelligent component 235. To enable an agent 110 to determine a privacy setting that determines a portion of information 210 that is utilized to infer intent, privacy component 215 can comprise a privacy editor 315 which facilitates establishing a privacy profile 325. Privacy editor 315 can include a graphical user interface (not shown) that allows agent 110 to opt for a predetermined level of privacy (e.g., high (H), medium (M), or low (L)). Alternatively, or in addition, privacy editor can be provided through a webpage maintained by service platform 130, or a software developer that produces software application 115. Privacy editor can be accessed asynchronously and as often as agent 110 desires. Once agent 110 determines a privacy setting, privacy editor can save the settings in a privacy profile 375 which can be encrypted. The latter can be stored within data store 245 or as a part of user intelligence 235. It should be appreciated that agent 110 can determine a privacy profile for multiple software applications that are registered within an intent-compensation ad-funded software program. For example, agent 110 can determine a low level of privacy for a game application, which is utilized for entertainment purposes, whereas the user can suppress substantially all information that is generated through utilization of a software application employed for confidential work related activities. It should further be appreciated that when agent 110 comprises a group of users, like in instances in which software application 115 is installed and executed in a server that facilitates simultaneous use of the application by multiple disparate users (e.g., a school buys a site license for a word processing program, or a flight simulator application, or substantially any application) each of the users can establish personal privacy profile.

To infer user intent 120, intelligent component 235 can comprise a data miner component 335 and an analysis component 345. Data miner component can include a suite of utility application deployed by service platform in order to extract information in accordance with privacy profile 375; for instance, such utility applications can include a key logger which can be utilized when agent's privacy settings are set to low, or a monitor of data, such as tutorials downloaded from the internet in connection with software application 115. Analysis component 345 provides functionality to intelligent component and relies of data collected through data miner 345 to infer intent through semantic networks, multivariate regression, data fusion, and the like.

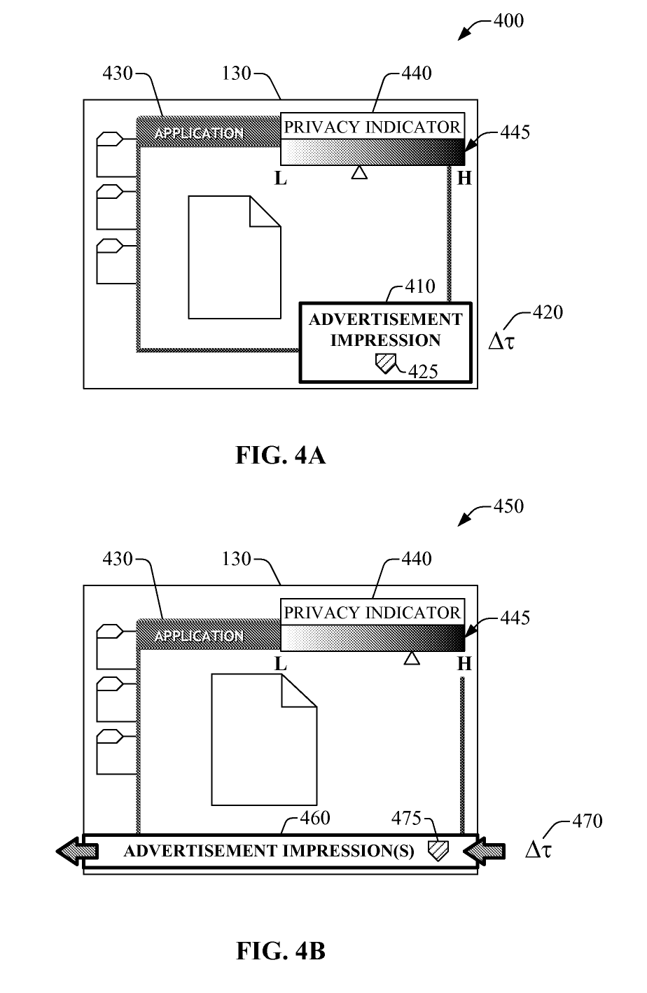

FIGS. 4A and 4B illustrate, respectively, example advertisement displays 400 and 450. In diagram 400 a display 130 conveys an advertisement impression 410 that persists for an interval Δτ 420. The advertisement impression can be programmed with an action/reward indicator conveyed through indicia 420; for example, indicia 425 can indicate an agent executing application 430 to (i) visit a specific website to obtain a discount an item related to the application 430, (ii) claim an available software-related compensation 150 through a compensation redemption webpage hosted by service platform, (iii) access an email or instant message application to obtain information related to a status of the agent's software-related compensation, or (iv) save the advertisement for later exposure. It should be appreciated that when the agent engages in suggested actions (i)-(iv), further targeted advertisement can be presented, such ad customization afforded by the user intelligence 235 available to the user in addition to the intent inferred through agent's actions when employing application 430. It is noted that the time span 420 of the ad impression can affect at least in part the magnitude of compensation, Δτ 420 can be partially determined by the agent executing application 430. Furthermore, advertisement impression can possess various indicia such as sound, images, etc.

Additionally, concurrently with advertisement impression 410, display 130 can present a privacy indicator 440 that summarizes a current level of privacy. For example, indicia 445 can comprise a color coded level of privacy wherein darker tones indicate higher levels of privacy. It should be appreciated, notwithstanding, that substantially any suitable indicia that conveys a scale level can be employed by privacy indicator 410.

In diagram 450, an advertisement impression is conveyed through a side-to-side scrolling bar 460. Multiple ad impressions can be delivered in an ad persistence interval Δτ 470. An action-compensation indication 475 is also displayed to the agent, with substantially the same content as described above in connection with indicator 425.

It is to be noted that the receiving an ad impression in format 410 or 460, with associated indicia, can be based at least in part on available display real state in the device utilized to execute application 430. As an example, a scrolling ad impression 460, with limited or substantially absent sound and imagery, can be exploited in a cell phone display, whereas format 470 can be employed in an electronic device with a large display, such as a monitor, console, or TV display.

It should be appreciated that the intent-compensation ad-funded software model can be utilized pervasively in substantially any electronic device or combination of electronic devices that can exploit a software application for operation, or control and monitoring, and can establish communication links 175 and 178 with a service platform. As an example, a smart fridge can be combined with a PDA, or smart phone, to exploit ad-funded software in the following illustrative manner. A “scheduler/memo pad” software application (e.g., application 115) can be downloaded in the PDA from a service platform 130. As a part of the ad-funded software model, an agent (e.g., agent 110) can agree to have a portion of contents included in the “memo pad” application monitored by the service platform (e.g., by customizing a specific privacy profile 325) in exchange for receiving advertisement in the PDA and associated software-related application. As the agent utilizes the “memo pad” application to set up grocery lists, advertisements related to grocery products are presented to the agent in either a static impression 410 or a scrolling impression 460—it should be appreciated that such ads can carry active coupons for the advertised products conveyed through action indicia 425 or 475—and after a number of advertisement impressions, the agent can receive a software-related compensation containing a driver for the memo pad application that enables connectivity with a smart fridge. Through the driver, the smart fridge can convey items for a grocery list to the “memo pad” application based at least in part on availability of such item in the fridge; for instance, items bought by the agent that have packaging with RFID (radio frequency identification) tags can facilitate the fridge to monitor a stock of such items, in such a manner that when the items reach a threshold level the smart fridge can wirelessly convey to the “memo pad” application in the agent's PDA the need for said items. It is to be noted that other combinations of pervasive device utilization of the ad-funded software model can be implemented.

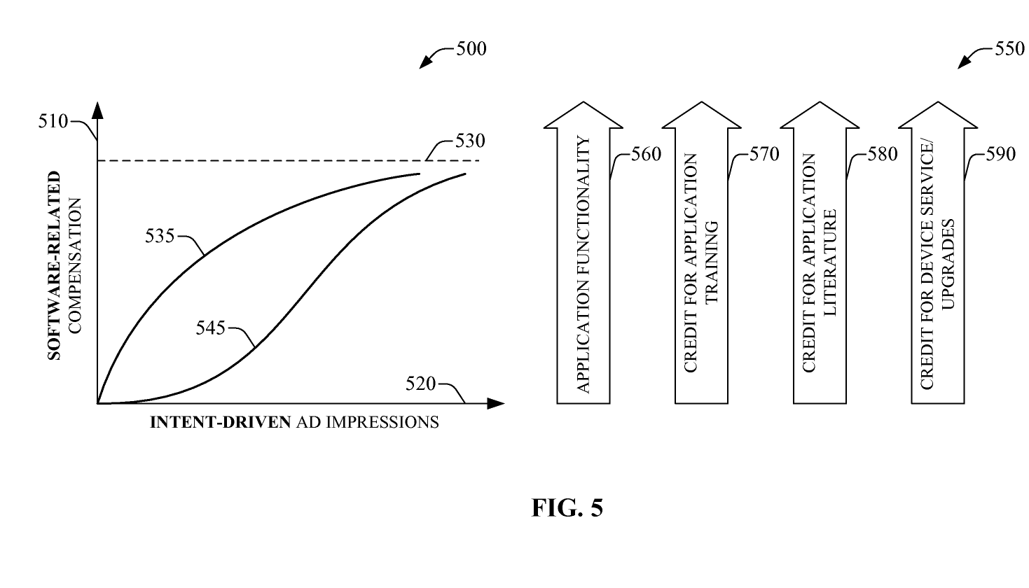

FIG. 5 are diagrams 500 and 550 that illustrate, respectively, accumulation profiles of software-related compensation and example compensations. In diagram 500 two profiles for software-related compensation 510 accumulation as a function of intent-driven advertisement impressions 520 are presented. Compensation accumulation profiles can be established by service platform 130, through compensation component 145, and can be fixed until compensation reaches an accumulation threshold 530. Such scheme for compensation accumulation can be useful in scenarios in which intent is explicit and substantially negligible inference takes place in determining such intent. Alternatively, an initial profile can be evolved autonomously by interface 150 based at least in part on the degree of confidence on inferred agent's intent. It is to be noted that a confidence metric can become more robust as available information increases, such an increase can be determined by changes in the agent's privacy profile 325. For example, profiles 535 and 545 can be autonomously evolved or fixed. Profile 535 can correspond to a situation in which privacy settings provide a substantial amount of information to be directed towards intent determination, thus intent-driven advertisement impressions can be targeted more effectively and awarded compensation can be readily delivered. Alternatively, profile 545 can correspond to a situation in which information surrounding a software application (e.g., application 115) is scarce and thus a confidence metric related to agent's intent is low and therefore ad impressions can fail at eliciting an action from the agent. Accordingly, compensation is delivered slowly until sufficient user intelligence and data are accumulated in order to attain better intent confidence metrics and associated advertisement customization.

Diagram 550 illustrates four classes of software-related compensation that can fund a software application, or related costs, through intent-driven advertisement. As advertisement impressions are accumulated, compensation 560 can include increasing application functionality. Such functionality can comprise add-on drivers or template that simplify specific tasks, or satisfies specific needs, of an agent 110; for instance, as a result of intent-driven ad exposure the following functionalities can be added: (1) customized Microsoft® Visio® stencils (e.g., a stencil that includes Feynman diagrams, which are objects readily used in high-energy and many-body physics, or a stencil that includes elements for home design can be added to the set of available stencils in the version of Visio® that the agent utilizes); (2) a set of maps for specific regions of a fantasy world or a set of powers and health-preserving tokens in an MMOG can be included in the agent's current subscription; (3) drivers that facilitate connectivity among disparate electronic devices with wireless capabilities (similarly to those discussed above in connection with the PDA and the smart fridge), such as autonomous download of music files from a pocket computer, a digital media player such as Zune®, or smart phone to a high-fidelity stereo system, or movies to DVD players and other movie/image rendering devices, such as thin-film smart paper; (4) a library of landmarks, restaurants and diners, art galleries, hotels, coffee shops, kids museums, parks, trails, and the like can be provided for a GPS-based navigation system; (5) a translation driver to be employed for digital map reading or for vehicle navigation in a foreign country; (6) fraud alerts and online and wireless banking security add-ons; and so forth.

Additionally, compensation can also include credit for benefits such as application training 560 which can comprise online and onsite seminars and lectures; application literature 580 such as online tutorials, hardcopy and electronic books, commentaries and columns by experts, specially in sophisticated simulation applications like investment and trade simulations, data warehouse applications, digital art authoring applications; and credit for device service 590, which can include service of computers like installing and tuning spam-filters, as well as “phising” mitigation applications, setting firewalls and related security, various software installations and removal, and the like.

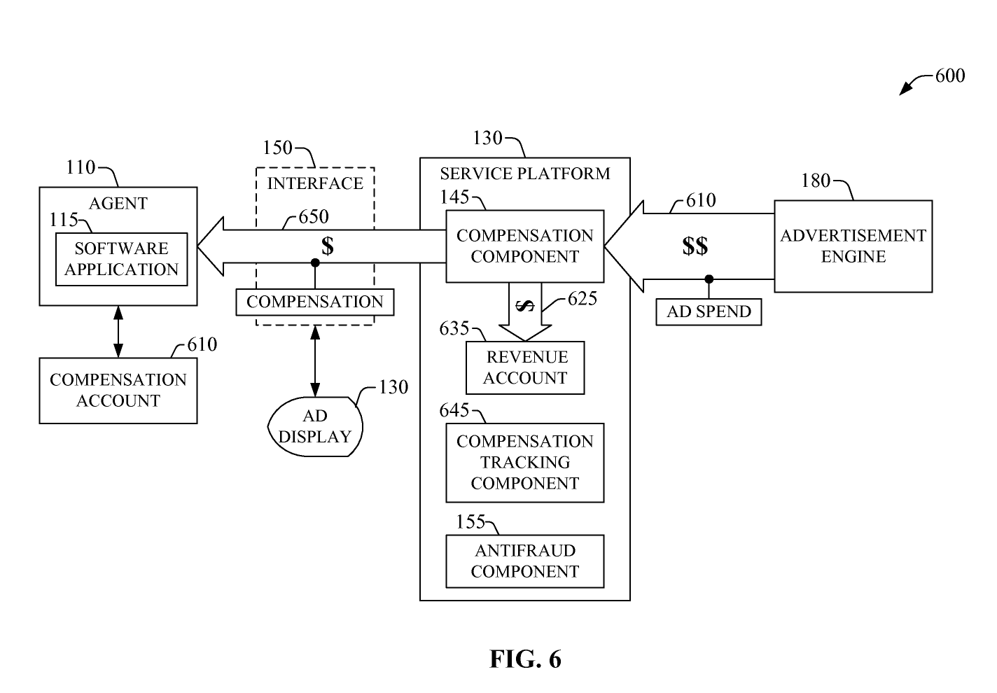

FIG. 6 illustrates a block diagram of an example system 600 that employs ad spend to compensate an agent in exchange of the agent's intent and display of an intent-driven advertisement. In system 600, service platform 130 receives a payment 610 to display advertisements for advertisement engine 180. In an aspect, compensation component 145 processes ad spend 610 and splits ad spent 610 in two streams: Monies 625 directed toward a revenue account of the service platform 130, and compensation monies 650 that can be delivered to compensation account 610 of agent 110. It should be appreciated that while a single agent 110 is illustrated in diagram 600, multiple users can be included in agent 110. As discussed in connection with example system 100, compensation 650 is delivered to agent 110 in exchange of agent's intent (e.g., intent 120; not shown in FIG. 6) and intent-driven advertisement impression(s), or ad display 130. As discussed above, compensation 650 is typically related to software application 115, and it possess monetary value. Depositing compensation 650 in agent's compensation account 610 can facilitate rewarding the agent. It should be appreciated that compensation in account 610 can be exchanged for credits (e.g., credits 570, 580 and 590) or it can be utilized to act upon action indication conveyed in advertisement impressions (e.g., action indicators 425 or 475). Upon delivery of compensation 650 to agent 110, compensation tracking component 645 can account for payments, retain compensation records, store type and quantity of compensation delivered to agent 110, and also monitor a current level of compensation for agent 110 to ensure compensation fails to surpass a compensation limit (e.g., compensation threshold 530).

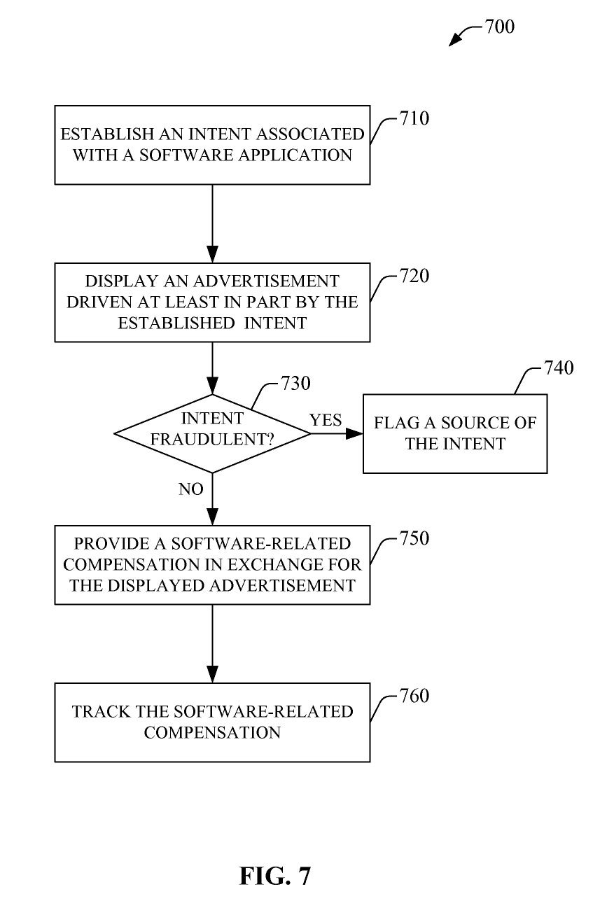

In view of the example systems, and associated aspects, presented and described above, methodologies for funding software through advertisement in exchange for an agent's intent that may be implemented in accordance with the disclosed subject matter can be better appreciated with reference to the flowcharts of FIGS. 7, 8 and 9. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers.

FIG. 7 presents a flowchart of an example method for funding software through intent-driven advertisement. At step 710 an intent associated with a software application is established. In an aspect, such intent can be explicit, whereby an agent that utilizes the software application declares its intent; e.g., a user of a database management system requests information on a specific topic of records compression utilizing wavelet-based compression. Such a declarative, explicit intent can result an advertisement for literature or training associated with wavelet compression. In addition, intent can be extracted by a service platform through an interface (e.g., interface 150) that can infer the agent's intent through analysis of information generated by the agent and associated with the software application. Such a scenario corresponds to implicit determination of intent.

At step 720 an advertisement based at least in part on the established intent is displayed. In an aspect, a service platform can act as an advertisement service or broker to various merchants (e.g., online retailers, or offline merchants). Thus, based on established intent, the service platform can display a targeted ad impression. Such an ad impression can include an action cue or an instantaneous reward, such as a coupon or gift associated with the software application that is utilized by the agent generating the information that leads to the intent.

Act 730 is validation act that checks whether the established intent is fraudulent. In the affirmative case the source of the intent is flagged and multiple subsequent action can be pursued, such as monitoring the source of intent, active mitigation of fraudulent activities, counter-fraud measures such as increased number of compensation-free advertisement impressions conveyed to the source of fraud, fraud resolution, and so on. In case intent is legitimate, at act 750 a software-related compensation in exchange for the displayed intent-driven advertisement is provided. The compensation is typically delivered by adhering to a compensation accumulation profile versus advertisement impressions that can be based at least in part on privacy settings that determine a volume of information received to establish intent. In an aspect, a compensation component associated with a service platform (e.g., service platform 130) delivers the compensation. The compensation possesses monetary value and it is related to the software application that originates the received intent. In an aspect, as discussed above in connection with FIG. 5, compensation can be directed toward application functionality. Alternatively or in addition, software related compensation can be associated with credit toward aspects (e.g., training, literature, service) that support or enhance the utilization of the application and thus the generation of intent. At act 760 the provided software-related compensation is tracked to ensure an adequate level of compensation is conveyed.

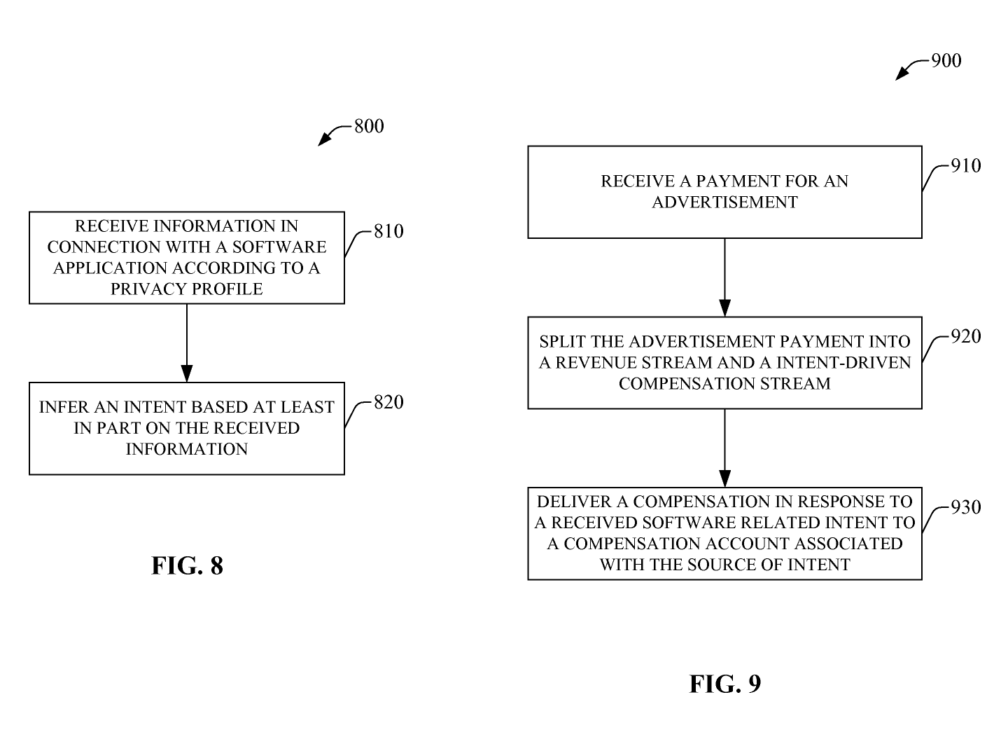

FIG. 8 presents a flowchart of an example method for establishing intent associated with a software application registered in an intent-compensation ad-fund software model. At act 810 information in connection with software application(s) is received according to a privacy profile. In an aspect, the privacy profile can be determined by an agent that utilizes the software application and conveys the information. It should be appreciated that the conveyed information can typically be implicit, rather than explicit. For example, implicit information can include a number of instances in which the software application has been started in a specific period of time, a set of disparate applications that are generally utilized when the software application is utilized, a set of features of the software application and how frequently such features are utilized.

At act 820 an intent based at least in part on the received information is inferred. Such an inference can be based on semantic networks, where propagation of concepts of disparate level of complexity can support an inference of an intent based on elements of the received information and assumed or known, or a combination of both, relationships are incorporated in the generation of an intent. Models utilized for intent generation can provide with a confidence metric that can reflect the extent to which a predicted intent is reliable.

FIG. 9 presents a flowchart of an example method for generating a software-related intent-based compensation in response to advertisement exposure. At act 910 a payment for an advertisement is received. Typically such a payment is received by a service provider from an external advertisement agency or a merchant that advertises its own merchandise. Alternatively, or in addition, the service platform that receives the payment for the advertisement can itself advertise its own services or products related with a service.

At act 920 the payment for advertisement is split in two streams: a revenue stream and a compensation stream. Such a division of advertisement can fund an intent-based compensation scheme wherein software is funded through a series of compensation events in exchange for an agent's intent, and for exposure to intent-driven advertisement. Directing a fraction of ad spend can benefit both the service platform and the advertiser: (i) The service platform mitigates user attrition by directly compensating, through software-related rewards, the user with a reward of monetary value. (ii) The merchant, or advertiser, that delivers the advertisement can have access to a highly customized audience which has manifested implicitly or explicitly its intent; thus, substantially increasing the effectiveness of an advertisement campaign.

At act 930, a reward, or compensation, is delivered in response to a received, software-related intent to a compensation account associated with the source of intent. Typically, the source of intent is an agent that utilizes the software application. Moreover, the compensation can be accumulated in the compensation account until a sufficiently high level of compensation allows the agent that delivers intent to access a software-related compensation. It should be appreciated that such scenario can be identified with a forward compensation scheme, wherein compensation is build up as the intent is cumulatively received at a service platform. Alternatively, or in addition, in software-related intent-based compensation, it can be possible to provide a backward compensation, in which a specific level of compensation is provided to an agent in exchange for prospective intent to be conveyed. For example, a user buys a license of a software application that is fully functional at a discounted price (e.g., the discount is the software-related compensation); however, in order to utilize the application the user registers to receive intent-driven advertisement for a specific period of time which can typically be related to the magnitude of the provided discount.

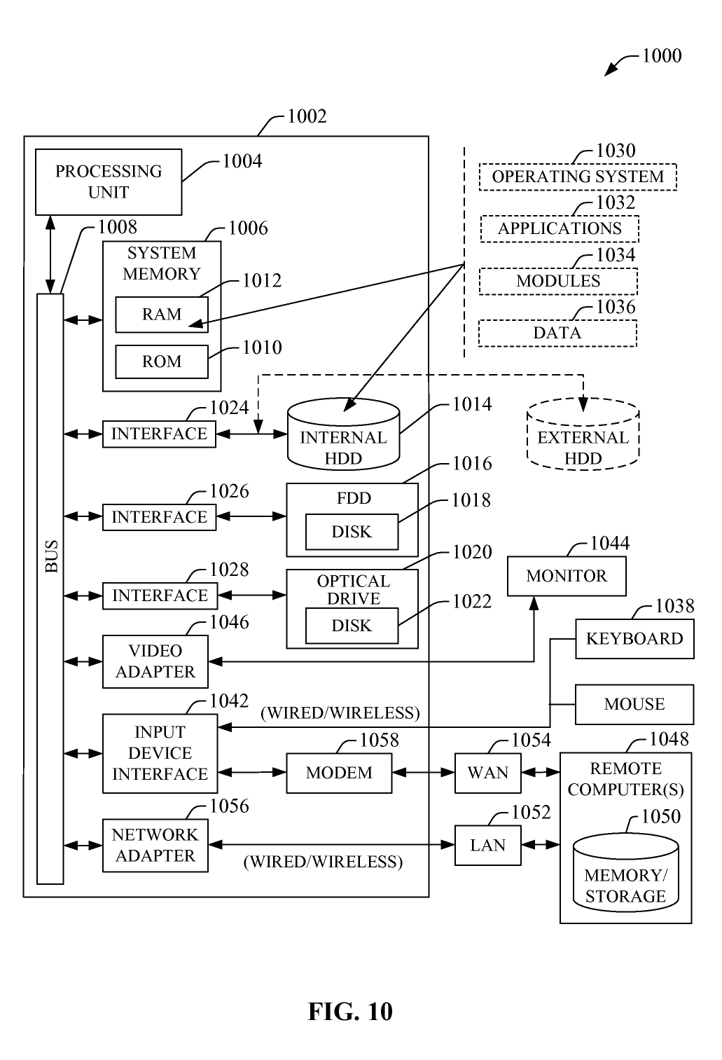

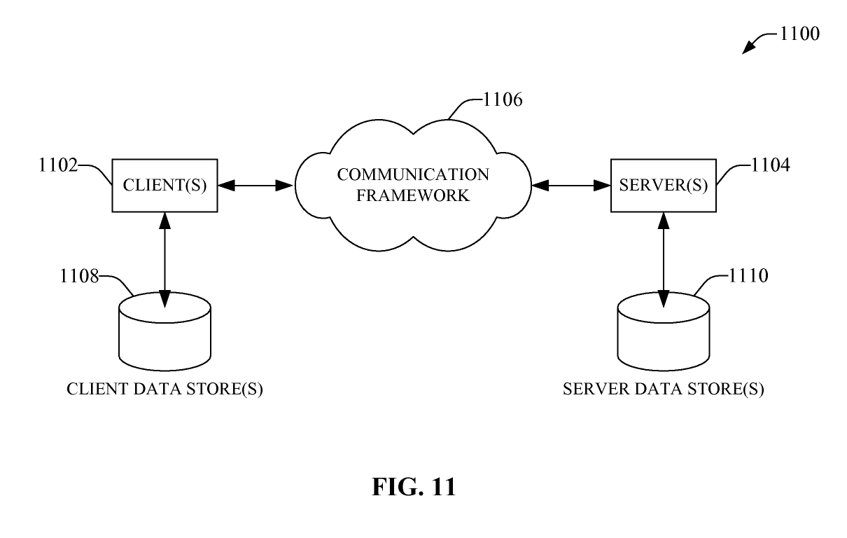

In order to provide additional context for various aspects of the subject specification, FIGS. 10 and 11 and the following discussions are intended to provide a brief, general description of a suitable computing environment 1000 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

In FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 408 via an interface, such as a video adapter 1046. In addition to the monitor 444, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

FIG. 11 illustrates a schematic block diagram of a computing environment in accordance with the subject specification. The system 1100 includes one or more client(s) 1102. The client(s) 1102 can be hardware and/or software (e.g., threads, processes, computing devices). The client(s) 1102 can house cookie(s) and/or associated contextual information by employing the specification, for example.

The system 1100 also includes one or more server(s) 1104. The server(s) 1104 can also be hardware and/or software (e.g., threads, processes, computing devices). The servers 1104 can house threads to perform transformations by employing the specification, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the terms “includes,” “possesses,” and the like are used in either the detailed description or the claims, such term is intended to be inclusive in a manner similar to the term “comprising” as “comprising” is interpreted when employed as a transitional word in a claim.

What is claimed is:

1. A system that compensates of an agent through advertising spend in exchange for the agent's intent related to utilization of a software application, the system comprising:
a component that displays advertisements to a user of a software application within a device that executes the software application,
a compensation component that compensates the user through accrued advertising revenue in connection with the displayed advertisement; and
a fraud component that mitigates fraudulent compensation.

2. The system of claim 1, the agent's intent is established through an interface component comprising:
a privacy component that determines information that is collected; and
an intelligent component that infers intent based at least in part on the collected information.

3. The system of claim 2, the privacy component includes a privacy editor that facilitates creation of a privacy profile, wherein the privacy profile dictates the information that is collected.

4. The system of claim 1, wherein the compensation component determines a compensation accumulation profile as a function of displayed advertisement.

5. The system of claim 4, wherein the compensation accumulation profile is evolved autonomously based at least in part on the degree of confidence on an inferred agent's intent.

6. The system of claim 1, wherein the compensation includes at least one of an add-on driver or a template that increases a functionality of the software application.

7. The system of claim 1, wherein the compensation is at least of a credit for training of the software application, a credit for literature associated with the software application, or a credit to service the device that executes the software application.

8. The system of claim 6, wherein the add-on driver includes at least one of a customized stencils for a drawing application; a set of maps for specific regions of a fantasy world in a massively multiplayer online game; a driver that facilitates connectivity among a device that executes the application and a disparate device; or a library of landmarks, restaurants and diners, art galleries, hotels, coffee shops, kids museums, parks, trails, for a Global-Positioning-System-based navigation system.

9. The system of claim 1, wherein a displayed advertisement includes at least one of a static impression or a scrolling impression; and an impression persists for an interval of time determined at least in part by the agent.

10. The system of claim 9, the displayed advertisement further comprising an action indicator that provides an instantaneous compensation.

11. A method for compensating an agent that utilizes a software application, the method comprising:
establishing an intent associated with the software application;
displaying an advertisement driven at least in part on the received intent; and
providing a software-related compensation in exchange for the displayed intent-driven advertisement.

12. The method of claim 11, further comprising verifying that the received intent is legitimate, wherein an illegitimate intent results in flagging the source of intent.

13. The method of claim 11, further comprising tracking the software-related compensation.

14. The method of claim 11, establishing an intent further comprising:
receiving information related to the software application according to a privacy profile; and
inferring the intent based at least in part on the received information.

15. The method of claim 14, wherein the privacy profile is set by the source of the received information.

16. The method of claim 11, providing a software-related compensation in exchange for the displayed intent-driven advertisement further comprising:
receiving a payment for an advertisement;
splitting the advertisement payment into a revenue stream and an intent-driven compensation stream; and
delivering the software-related compensation to a compensation account associated with a source of intent.

17. The method of claim 11, providing a software-related compensation in exchange for the displayed intent-driven advertisement further comprising adhering to a compensation accumulation profile based at least in part on privacy settings.

18. The method of claim 11, wherein the software-related compensation includes at least one of an add-on driver or a template that increases a functionality of the software application.

19. The method of claim 11, wherein the software-related compensation is at least one of a credit for training on the software application, a credit for literature associated with the software application, or a credit to service the device that executes the software application.

20. A computer program product comprising a computer-readable medium comprising code stored thereon that, when executed by a computer, causes the computer to carry out the following acts:
establishing an intent associated with the software application;
verifying that the received intent is legitimate, wherein an illegitimate intent results in flagging the source of intent;
displaying an advertisement driven at least in part on the received intent;
providing a software-related compensation in exchange for the displayed intent-driven advertisement; and
tracking the software-related compensation.
